(19) United States
(12) Patent Application Publication
(10) Pub. No.: US 2008/0263479 A1
(43) Pub. Date: Oct. 23, 2008

(54) Touchless Manipulation of an Image

(75) Inventors: Gerrit-Jan Bloem, Eindhoven (NL); Njin-Zu Chen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/094,669

(22) PCT Filed: Nov. 21, 2006
(86) PCT No.: PCT/IB06/54354

§ 371 Date: May 22, 2008

(30) Foreign Application Priority Data
Nov. 25, 2005 (EP) 05111291.0

(51) Int. Cl. G06F 3/048

(52) U.S. Cl. 715/863

(57) ABSTRACT

The invention relates to a method of providing touchless manipulation of an image through a touchless input device (210), the method comprising selecting a property of a manipulation mode with the image in response to touchless user interaction along a first axis with respect to a plane of a sensing region (206, 208) of the touchless input device, and manipulating the image in response to touchless user interaction along a second axis substantially orthogonal to the first axis according to the selected property of the manipulation mode. The invention further relates to a computer program product, a computer storage medium, a display device and a medical workstation.

The invention relates to a method of providing touchless manipulation of an image through a touchless input device.

The invention further relates to a computer program product to be loaded by a computer arrangement, comprising instructions for providing touchless manipulation of an image through a touchless input device, the computer arrangement comprising a processing unit and a memory, wherein the computer program product, after being loaded, provides said processing unit with the capability to carry out the tasks of providing touchless manipulation of the image.

The invention further relates to a computer readable storage medium having recorded thereon data representing to perform the touchless manipulation of the image.

The invention further relates to a display device comprising a display for displaying an image and a touchless input device for providing touchless manipulation of the image, the touchless input device comprising a processor configured to perform the touchless manipulation of the image.

The invention further relates to a medical workstation comprising a display for displaying an image and a touchless input device for providing touchless manipulation of the image, the touchless input device comprising a processor configured to perform the touchless manipulation of the image.

Touchless input devices are well known. For example, US patent application 2002/0000977 A1 discloses a three-dimensional interactive display system comprising a transparent capaciflector camera formed on a transparent shield layer on a screen surface which is able to detect an object such as a probe or finger intruding in the vicinity of that screen surface.

U.S. Pat. No. 6,025,726 discloses an alternative to capacitive sensing in which electric field sensing is used to provide a touchless sensing region.

U.S. Pat. No. 6,130,663 discloses an other alternative in which an electro-optical scanner is used to provide optical touchless activation of a controlled element, such as a graphic element of a computer display, in response to the presence of a controlling object, such as a finger, in a predetermined field of free space separated from the element. Furthermore, touchless input devices enable more advanced user interaction. For example, US Patent Application 2005/0088409 discloses a method, computer program product, computer readable storage medium and input device that provides a display for a Graphical User Interface (GUI) comprising the step of displaying a pointer on a display in a position corresponding to the position of a user's hand in a plane of a sensing region of a touchless input device. In particular, the method further comprises the step of displaying an indication on the display of the distance between the user's hand and either a reference point located in or adjacent the sensing regions or a reference plane, parallel with the first plane and located through or adjacent the sensing region. By displaying the indication the user is provided with an indication of the sensitivity for any given hand position to manipulate the displayed pointer. The sensitivity is determined by the accuracy to which the touchless input device can measure the position of the user's hand. The accuracy increases when the hand is closer to the display whereas it decreases when the hand moves further from the display. This, however, limits the predictability of the interaction of the user with the device.

It is an object of the invention to provide a method that enables a user to influence the predictability of the interaction with a touchless input device. To achieve this object, the invention provides a method according to the opening paragraph the method comprising selecting a property of a manipulation mode with the image in response to touchless user interaction along a first axis with respect to a plane of a sensing region of the touchless input device, and manipulating the image in response to touchless user interaction along a second axis substantially orthogonal to the first axis according to the selected property of the manipulation mode. By linking a property of a manipulation mode to a first axis with respect to a plane of a sensing region of the touchless input device, a user can change that specific property my moving an object, for example his hand, along that axis. Consequently, the resulting manipulation mode is applied to the image by moving the object along a second axis giving a predictable manipulation of the image.

In a further example of the method according to the invention the second axis is substantially parallel to the plane. By using an axis that is substantially parallel to the plane as the axis along which the user can manipulate the interaction mode, it is clear to the user which movement gives the desired manipulation of the image.

In a further example of the method according to the invention, the method further comprises displaying the property of the manipulation mode. By displaying the property of the manipulation mode, the user gets additional feedback about the selected property and it's consequence for the manipulation mode.

In a further example of the method according to the invention the displayed property of the manipulation mode is proportional to a value of the property. By making the displayed property proportional to its value, the user gets further feedback about the selected property. For example, when the property has a high value, the displayed property has a larger size and when the property has a low value, the displayed property has a smaller size.

In a further example of the method according to the invention the manipulation mode is one of brightness, contrast, zoom or rotation and the property is a step size of the respective manipulation mode. By setting the step size along one axis and using an orthogonal axis for the manipulation mode, the user can easily distinguish between setting the step size and performing the manipulation mode by moving an object, for example a finger, along a corresponding axis.

It is a further object of the invention to provide a computer program product that enables a user to influence the predictability of the interaction with a touchless input device. To achieve this object, the invention provides a computer program product to be loaded by a computer arrangement, comprising instructions for providing touchless manipulation of an image through a touchless input device, the computer arrangement comprising a processing unit and a memory, the computer program product, after being loaded, providing said processing unit with the capability to carry out the following task:

selecting a property of a manipulation mode with the image in response to touchless user interaction along a first axis with respect to a plane of a sensing region of the touchless input device, and manipulating the image in response to touchless user interaction along a second axis orthogonal to the first axis according to the selected property of the manipulation mode.

It is a further object of the invention to provide a computer readable storage medium that enables a user to influence the predictability of the interaction with a touchless input device, the computer readable storage medium having recorded thereon data representing instructions for performing the method or any of the examples of the method according to the invention.

It is a further object of the invention to provide a display device that enables a user to influence the predictability of the interaction with a touchless input device, the display device comprising a display, the touchless input device and a processor configured for performing the method or any of the examples of the method according to the invention.

It is a further object of the invention to provide a medical workstation that enables a user to influence the predictability of the interaction with a touchless input device, the medical workstation comprising a display and the touchless input device, the touchless input device comprising a processor configured to perform the method or any of the examples of the method according to the invention.

The object and the same advantages are achieved by the computer program product, the computer readable storage medium, the display device and the medical workstation as are described with reference to the method.

These and other aspects of the invention will be apparent from and elucidated with reference to the embodiments described hereinafter as illustrated by the following Figures:

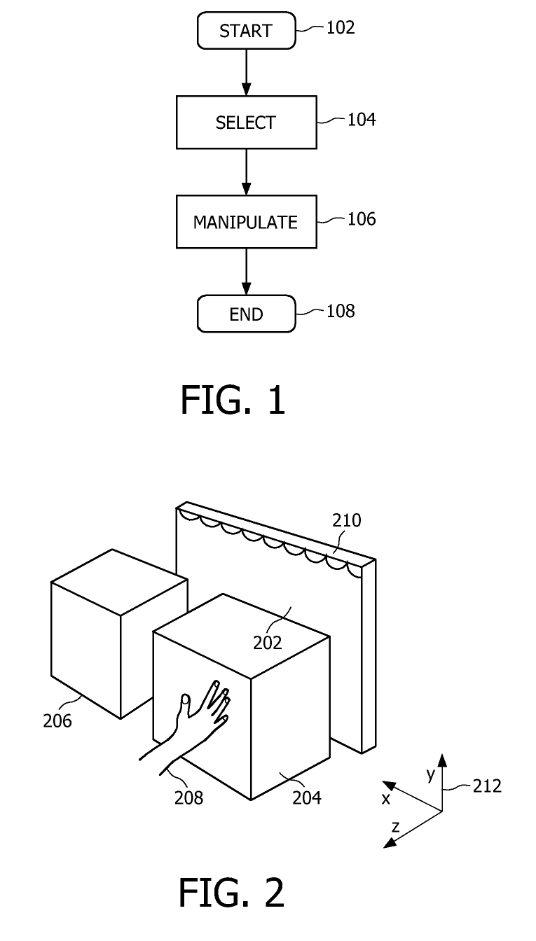

FIG. 1 illustrates a method according to the invention in a schematic way;

FIG. 2 illustrates a touchless input device with touchless manipulation of a user's hand;

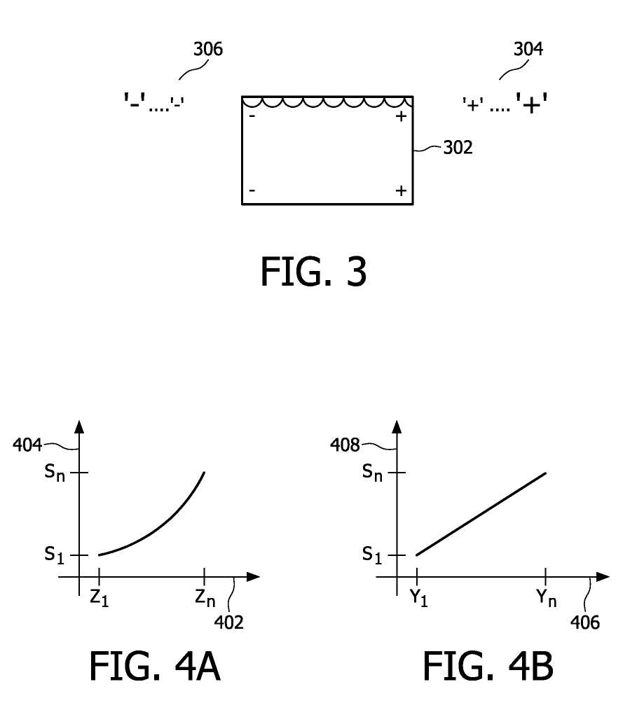

FIG. 3 illustrates visual feedback of a property of a manipulation mode;

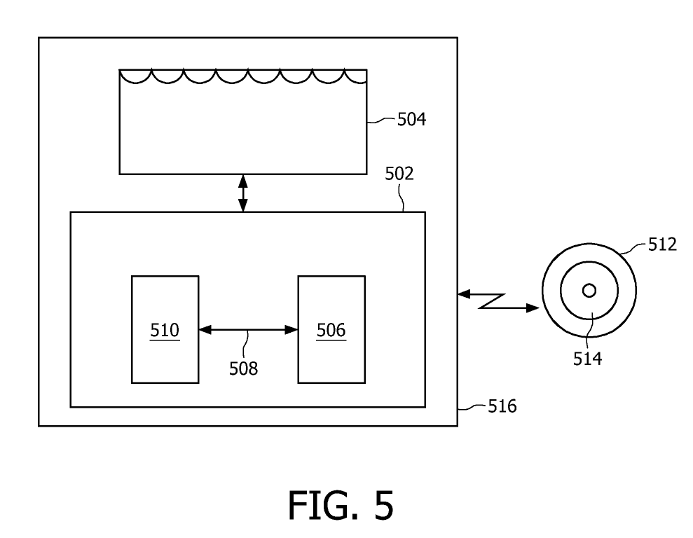

FIG. 4a illustrates a relation between a step size and the touchless manipulation of a user's hand along an axis, when the axis is the z-axis;

FIG. 4b illustrates a relation between a step size and the touchless manipulation of a user's hand along an axis, when the axis is the y-axis;

FIG. 5 illustrates a display device comprising a touchless input device according to the invention.

FIG. 1 illustrates a method according to the invention in a schematic way. In order to explain the method, reference is made to FIG. 2. FIG. 2 illustrates a touchless input device 210 with touchless manipulation of a user's hand 208. The space in which the position of the user's hand can be detected in a sensing region is represented by 206 and 208. Although the space is represented by two “boxes” this is for illustration purposes only, because the whole space can be used. The touchless input device 210 is connected to a plane 202. In a typical application, this plane 202 is formed by a display and the sensing region is formed in front of the display by the touchless input device 210. The method starts with an initialization step S102. An orthogonal coordinate system is assigned to the space of the sensing region. Two dimensions of that system are assigned functions: one for selection of a property of manipulation mode, the other for manipulating image data in response to touchless user interaction. In FIG. 2, as an example, a Cartesian coordinate system is used. A Cartesian coordinate system 212 is assigned to the space of the sensing region of the touchless input device of which the x-axis runs substantially parallel to a plane 202 of a sensing region of the touchless input device 210 as indicated in FIG. 2. The y-axis runs orthogonal to the x-axis substantially parallel to the plane 202 and the z-axis runs orthogonal the x-axis substantially perpendicular to the plane 202. Further, the x-axis is divided into two regions: an increase and a decrease region. When a user holds an object, such as the user's hand 208 along the x-axis within the increase region, a value of a manipulation mode, such as zoom is increased. When the user holds the object, such as the user's hand 208 along the x-axis within the decrease region, the value of the manipulation mode is decreased.

Further one of the remaining axes is used to change a property of the value of the manipulation mode. For example, the step size may be assigned to the z-axis, but the y-axis may be used as well. When the user moves an object, such as the user's hand 208 along this z-axis in one direction, the value of the property is increased. When the user moves the object, such as the user's hand 208 along the z-axis in the other direction, the value of the property is decreased.

The remaining steps of the method are explained with reference to an application in which a user wants to manipulate an image that is displayed by a display that is connected to the touchless input device as described above. For this purpose, a user a user has chosen the manipulation mode with which he wants to manipulate the image. Non-limiting examples of manipulation modes are: zoom, rotate, window width, window level, contrast, brightness. Consider that the user has chosen to manipulate the image by zooming the image.

Within the next step S104, the user moves his hand along the z-axis to select the step size of the zoom factor, i.e. when he wants to zoom the image with a small step-size, he moves his hand in the decrease direction, for example towards the display. However, when he wants to zoom the image with a large step-size, he moves his hand in the increase direction, for example away from the display. This results in a certain step size of the zoom factor such as a step size of 20.

Within step S106, the user manipulates the image, i.e. zooms the image along the x-axis that was assigned to enable manipulation of the value of the manipulation mode. Consequently, the zoom factor is increased or decreased, by the set step size, here 20. The increase or decrease depends upon the position into which the hand is placed along the x-axis.

Changing i.e. increasing or decreasing, the step factor is accomplished by moving the hand along the z-axis after which the user can zoom the image with the newly set step size.

Adjusting the step size and applying it to the manipulation mode may be performed multiple times.

The method terminates in step S108, after which the manipulation mode and the property may be assigned to different axis of the Cartesian coordinate system.

FIG. 3 illustrates visual feedback of a property of a manipulation mode. In order to give a user feedback about the value of the property, predefined positions of the display 302 are used to display a visual indicator. For the predefined positions, the corners of the display as illustrated in FIG. 3 may be chosen to obscure the information displayed as little as possible. For a visual indicator a “+” sign is shown to indicate an increase in zoom factor and a “−” sign is shown to indicate a decrease in zoom factor. Other visual indicators like an arrow up or an arrow down may also be shown. Advantageously the size of the sign is proportional to the value of the property, i.e. it is larger when the step size is high and it is smaller when the step size is low. This is represented schematically by 304 and 306.

FIG. 4a illustrates a relation between a step size and the touchless manipulation of a user's hand along a z-axis. The axes of the illustrated graph are related to the axes with respect to a plane of the sensing region as described above. The axis 402 indicates the distance of an object to the sensing region of the touchless input device along the z-axis and the axis 404 indicates the step size of the value of the property. In the graph it is shown that the step size increases when the distance in the sensing region increases.

FIG. 4b illustrates a relation between a step size and the touchless manipulation of a user's hand along a y-axis. The axes of the illustrated graph are related to the axes with respect to a plane of the sensing region as described above. The axis 406 indicates the vertical movement of an object along the y-axis that is substantially parallel to the plane of the sensing region of the touchless input device. The axis 408 indicates the step size of the value of the property. In the graph it is shown that the step size increases linearly when the distance in the sensing region increases.

In both FIGS. 4a and 4b, the shape of the graph is an example, other shapes, i.e. relations between the position of an object and the value of the property are also plausible without departing from the concepts of the invention.

FIG. 5 illustrates a display device comprising a touchless input device according to the invention. The display device 516 comprises a computer 502 configured to generate, in accordance with the present invention, a screen display for a conventional flat panel display 504 with integral touchless input device, not shown, to which it is connected. The current invention can be applied to touchless input devices that give a three-dimensional coordinate of an object that is positioned or moved in the sensing region of the touchless input devices. Examples of such input devices are mentioned previously.

The computer comprises amongst others a processor 506 and a general purpose memory such as random access memory 510. The processor and the memory are communicatively coupled through software bus 508. The memory 510 comprises computer readable code comprising instructions designed to enable the processor 506 to perform the method according to the invention as previously described in cooperation with the touchless input device to which it is connected.

The computer readable code 514 can be downloaded onto the computer via a computer readable storage medium 512 such as a compact disk (CD) digital versatile/video disk (DVD) or other storage medium. The computer readable code 514 may also be downloaded via the internet and the computer comprises a suitable medium to enable these downloads.

Advantageously the invention is applied in a medical environment. Consider for example an operating theatre wherein a surgeon is operating on a patient. A medical workstation is provided in the operating theatre that shows medical images of the patients. The medical workstation comprises a touchless input device and a computer configured to generate, in accordance with the present invention, a screen display that allows the previously described user interaction. The images may be acquired before the operation, but they may also be acquired during the operation. The surgeon performs the operation in a sterile environment and should avoid direct contact with the workstation in order to maintain this environment. Here, the current invention allows the surgeon to manipulate the images without direct contact.

The order in the described embodiments of the method of the current invention is not mandatory, a person skilled in the art may change the order of steps or perform steps concurrently using threading models, multi-processor systems or multiple processes without departing from the concept as intended by the current invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. The mere fact that certain measures are recited in mutually different dependent claims does not indicate that a combination of these measures cannot be used to advantage.

1. Method of providing touchless manipulation of an image through a touchless input device (210), the method comprising:
selecting a property of a manipulation mode with the image in response to touchless user interaction along a first axis with respect to a plane of a sensing region (206, 208) of the touchless input device, and
manipulating the image in response to touchless user interaction along a second axis substantially orthogonal to the first axis according to the selected property of the manipulation mode.

2. Method according to claim 1, wherein the second axis is substantially parallel to the plane.

3. Method according to claim 1, further comprising displaying the property of the manipulation mode.

4. Method according to claim 3, wherein the displayed property of the manipulation mode is proportional to a value of the property.

5. Method according to claim 1, wherein the manipulation mode is one of brightness, contrast, zoom or rotation and the property is a step size of the respective manipulation mode.

6. A computer program product to be loaded by a computer arrangement, comprising instructions for providing touchless manipulation of an image through a touchless input device (210), the computer arrangement comprising a processing unit and a memory, the computer program product, after being loaded, providing said processing unit with the capability to carry out the following tasks:
selecting a property of a manipulation mode with the image in response to touchless user interaction along a first axis with respect to a plane of a sensing region (206, 208) of the touchless input device, and
manipulating the image in response to touchless user interaction along a second axis orthogonal to the first axis according to the selected property of the manipulation mode.

7. A computer readable storage medium (512) having recorded thereon data (514) representing instructions for performing a method according to claim 1.

8. Display device (516) for providing touchless manipulation of an image, the display device comprising a display (504), a touchless input device (210) and a processor (506) configured to perform a method according to claim 1.

9. Medical workstation (516) comprising a display (504) and a touchless input device (210) for providing touchless manipulation of an image, the touchless input device (210) comprising a processor (506) configured to perform a method according to claim 1.
